(19) United States
(12) Patent Application Publication
(10) Pub. No.: US 2026/0164106 A1
(43) Pub. Date: Jun. 11, 2026

(54) IMAGE PICKUP APPARATUS

(71) Applicant: CANON KABUSHIKI KAISHA, Tokyo (JP)

(72) Inventor: TAKAYUKI IWASA, Kanagawa (JP)

(21) Appl. No.: 19/359,999

(22) Filed: Oct. 16, 2025

(30) Foreign Application Priority Data
Dec. 10, 2024 (JP) 2024-215115

(51) Int. Cl. H04N 23/52

(52) U.S. Cl. CPC H04N 23/52

(57) ABSTRACT

An image pickup apparatus includes an image sensor, a heating element different from the image sensor, a duct disposed between the image sensor and the heating element, and forming a flow path for fluid inside the duct. The duct includes a first duct member thermally connected to the image sensor and having a first thermal conductivity, a second duct member thermally connected to the heating element and having the first thermal conductivity, and a first thermal resistance member disposed between the first duct member and the second duct member and having a second thermal conductivity lower than the first thermal conductivity.

### BACKGROUND

### Field of the Technology

The aspect of the disclosure relates to one or more embodiments of an image pickup apparatus having a heat dissipation structure.

### Description of the Related Art

The image pickup apparatus includes an image sensor, a processor element such as a CPU, a display element, etc., which are heating (heat-generating) elements, and a heat dissipation structure for cooling them. Japanese Patent Application Laid-Open No. 2013-093697 discloses an image pickup apparatus in which a material for a heat dissipation duct on the image sensor side inside the image pickup apparatus has a high thermal conductivity, and a material for a heat dissipation duct on the circuit board side has a low thermal conductivity.

### SUMMARY

One or more embodiments of an image pickup apparatus according to one or more aspects of the disclosure may include an image sensor, a heating element different from the image sensor, a duct disposed between the image sensor and the heating element, and forming a flow path for fluid inside the duct. The duct includes a first duct member thermally connected to the image sensor and having a first thermal conductivity, a second duct member thermally connected to the heating element and having the first thermal conductivity, and a first thermal resistance member disposed between the first duct member and the second duct member and having a second thermal conductivity lower than the first thermal conductivity.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are a front perspective view and a rear perspective view of an image pickup apparatus according to a first embodiment, respectively.

FIG. 2 is a block diagram illustrating the configuration of the image pickup apparatus according to the first embodiment.

FIG. 3 is an exploded perspective view of the image pickup apparatus according to the first embodiment.

FIG. 4 is a sectional view of the image pickup apparatus according to the first embodiment.

FIGS. 5A and 5B are front perspective views of a cooling structure according to a first embodiment while FIG. 5B illustrates a fan as a transparent view.

FIG. 6 is a rear perspective view of the cooling structure according to the first embodiment.

FIGS. 7A and 7B are a rear perspective view and an exploded perspective view of a duct according to the first embodiment, respectively.

FIGS. 8A and 8B are a rear perspective view and an exploded perspective view of a duct according to a second embodiment, respectively.

FIGS. 9A and 9B are a rear perspective view and an exploded perspective view of a duct according to a third embodiment, respectively.

FIGS. 10A and 10B are a rear perspective view and an exploded perspective view of a duct according to a fourth embodiment, respectively.

FIG. 11 is a schematic diagram illustrating a B-B section in FIG. 10A.

### DESCRIPTION OF THE EMBODIMENTS

Referring now to the accompanying drawings, a description will be given of embodiments according to the disclosure.

### First Embodiment

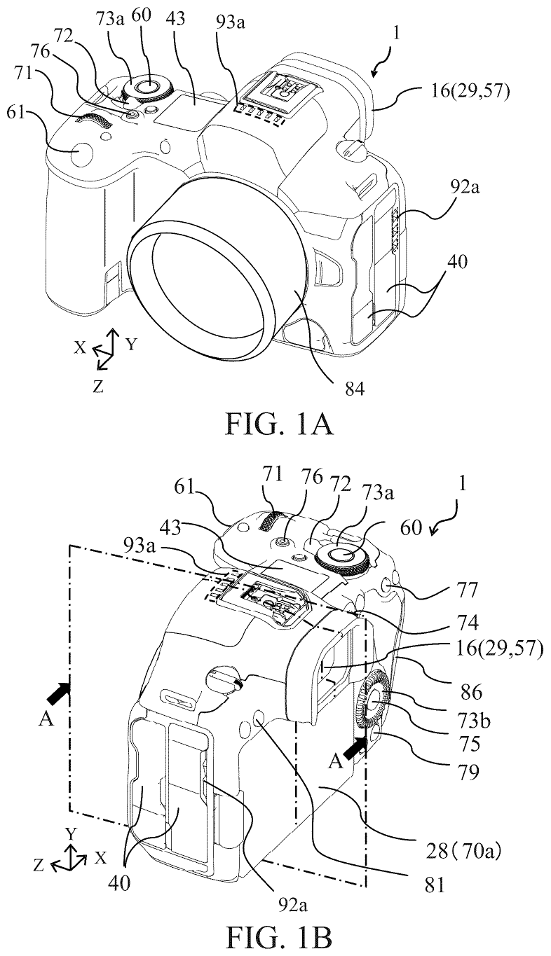

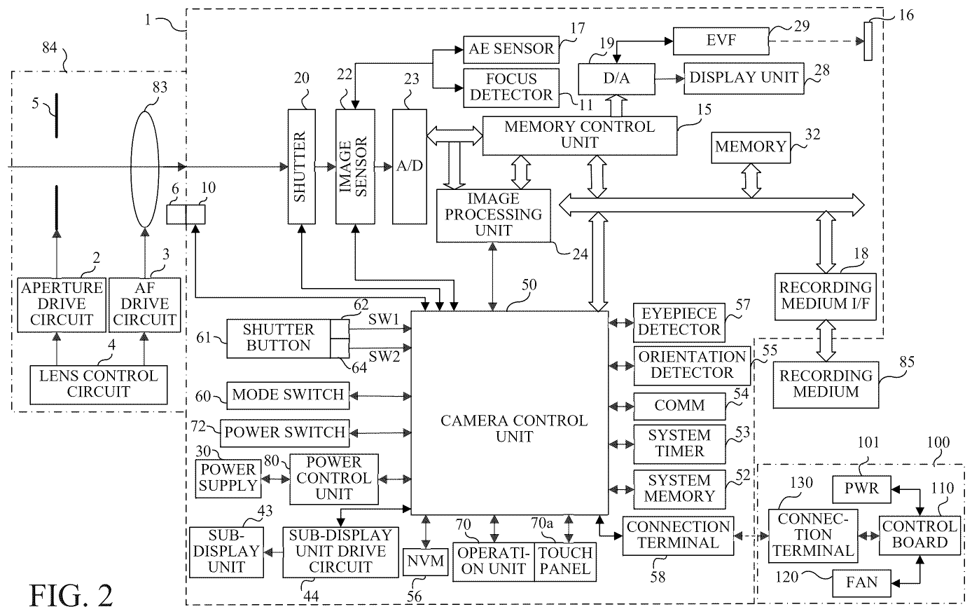

FIGS. 1A and 1B are front and rear perspective views of the image pickup apparatus 1, respectively. In these figures, a Z(-axis) direction is a front-to-back (optical axis) direction of the image pickup apparatus 1, an X(-axis) direction is a horizontal (width) direction, and a Y(-axis) direction is a vertical (height) direction. A lens unit (lens apparatus, interchangeable lens) 84 housing an imaging lens is attached to and detached from the front of the image pickup apparatus 1. FIG. 2 illustrates the optical and electrical configurations of the lens unit 84 and the image pickup apparatus 1. The imaging lens includes a plurality of lenses (represented by a single lens) 83 and an aperture stop (diaphragm) 5. A grip portion is formed on the right side of the front of the image pickup apparatus 1 when viewed from the rear side, and is held by the user with the right hand when the user holds the image pickup apparatus 1.

The top surface of the image pickup apparatus 1 includes a shutter button 61 operable by the user to issue an imaging command, a mode switch 60 operated to switch between a variety of modes, and a main electronic dial 71 operated to change a setting such as a shutter speed and an aperture value (F-number). The shutter button 61 is a two-step switch; when the first stage switch SW1 is turned on, an imaging preparation operation, such as autofocus (AF) and auto-exposure (AE), is performed, and when the second stage switch SW2 is turned on, an imaging operation is performed.

Also provided on the top surface of the image pickup apparatus 1 are a power switch 72 for powering on and off the image pickup apparatus 1, a first sub-electronic dial 73a operated to move a selection frame or advance images, and a video button 76 operated to start and stop moving image capturing. An operation unit 70 illustrated in FIG. 2 includes a variety of operation members provided on the top surface of the image pickup apparatus 1 described above, as well as another operation member described below.

A sub-display unit 43 is provided on the top surface of the image pickup apparatus 1, which displays a setting such as a shutter speed and an aperture value. The sub-display unit 43 includes a display element such as an LCD.

An eyepiece portion 16 is provided on the back of the image pickup apparatus 1, through which the user can view images and information displayed on an electronic viewfinder (EVF) unit 29 illustrated in FIG. 2. An eyepiece detector 57 is provided inside the eyepiece portion 16, detecting when the user is looking into the eyepiece portion 16. The rear surface of the image pickup apparatus 1 includes a rear display unit 28 that can be opened, closed, and rotated relative to the rear surface to display images and various information. The rear display unit 28 and EVF unit 29 include display elements such as LCDs and organic EL displays. The rear display unit 28 includes a touch panel (touch sensor) 70a that detects a user touch operation on the display surface (operation surface).

The rear surface of the image pickup apparatus 1 includes a second sub-electronic dial 73b that has the same function as that of the first sub-electronic dial 73a, a menu button 81 operated to display a menu screen on the rear display unit 28 for a variety of settings, and a multi-directional key 74. The multi-directional key 74 has eight directional keys: up, down, left, right, diagonally upper right, diagonally lower right, diagonally lower left, and diagonally upper left. The image pickup apparatus 1 performs an operation corresponding to the operated key.

The rear of the image pickup apparatus 1 includes a set button 75, which is mainly operated for confirming a selection, an AE lock button 77 operated in an imaging standby mode to fix an exposure state during imaging, and a playback button 79 operated to switch between an imaging mode and a playback mode. Operating the playback button 79 in an imaging mode can switch the image pickup apparatus 1 to a playback mode, and display an image recorded on a recording medium 85 illustrated in FIG. 2, on the display unit 28.

A terminal cover 40, located on the left side when viewed from the rear of the image pickup apparatus 1, protects the terminals (headphone jack, USB terminal, HDMI (registered trademark) terminal, etc.) that connect the image pickup apparatus 1 to an external device. A card cover 86, located on the right side when viewed from the rear of the image pickup apparatus 1, is a cover for opening and closing a card slot that stores the recording medium 85.

In FIG. 2, a camera communication terminal 10 and a lens communication terminal 6 are provided to enable communication between a camera control unit 50 in the image pickup apparatus 1 and a lens control unit 4 in the lens unit 84. The lens control unit 4 drives the aperture stop 5 via an aperture drive circuit 2 according to an instruction from the camera control unit 50, and moves a focus lens included in the lens 83 via an AF drive circuit 3.

In the image pickup apparatus 1, an image sensor 22 is a photoelectric conversion element, such as a CCD sensor or CMOS sensor, that converts an optical image (object image) formed by the imaging lens into an electrical signal. A shutter 20 is a focal plane shutter that controls the exposure of the image sensor 22.

An A/D converter 23 converts the analog signal output from the image sensor 22 into a digital signal (image data). An image processing unit 24 generates image data by performing resizing processes such as pixel interpolation and reduction, and color conversion processes on the image data acquired from the A/D converter 23 directly or via a memory control unit 15. The image data is written to a memory 32 via the image processing unit 24 or the memory control unit 15. The image processing unit 24 also performs a variety of calculation operations using the image data.

An AE sensor 17 detects the luminance of an object image using the image data from the image sensor 22. A focus detector 11 detects a defocus amount of the object image using the imaging data. The camera control unit 50 performs auto-exposure calculations to calculate the aperture value and shutter speed based on the detected luminance, and calculates the lens drive amount for AF based on the detected defocus amount. The image sensor 22 has a microlens and a plurality of photoelectric converters for each pixel, and functions as an imaging-surface phase-difference sensor.

A D/A converter 19 converts the image data stored in the memory 32 into an analog signal and supplies it to the rear display unit 28 and the EVF unit 29. The image data stored in the memory 32 is then displayed on the rear display unit 28 and the EVF unit 29. The display unit 28 and the EVF unit 29 display data on a display device such as an LCD or organic EL in accordance with the analog signal from the D/A converter 19.

A sub-display drive circuit 44 displays a setting, such as the shutter speed and aperture value, on the sub-display unit 43. A nonvolatile memory (NVM) 56 is an electrically erasable and recordable memory, and includes an EEPROM or the like. The nonvolatile memory 56 stores a constant and a program for the operation of the camera control unit 50.

The camera control unit 50 includes at least one processor, memory, etc., and controls the entire image pickup apparatus 1. A system memory 52 includes RAM, etc., stores a constant and a variable for the operation of the camera control unit 50, and loads the program read from nonvolatile memory 56. A system timer 53 counts the current time and measures the time for various controls.

The power supply unit 30 includes a primary battery, secondary battery, or AC adapter, etc. A power supply control unit 80 includes a circuit that detects whether a battery is installed, the battery type, and the remaining battery power, a DC-DC converter, and a switch circuit that switches between blocks to which power is applied. The power supply control unit 80 controls the DC-DC converter to supply the required voltage to each block, including the recording medium 85.

A recording medium interface (I/F) 18 is an interface with the recording medium 85. The recording medium 85 includes a semiconductor memory, a magnetic disk, etc. that records image data. A communication unit 54 transmits and receives video and audio signals to and from the outside via wireless or wired communication.

An orientation detector 55 detects the orientation of the image pickup apparatus 1 relative to the gravity direction using an acceleration sensor, gyro sensor, etc. The camera control unit 50 determines whether the orientation of the image pickup apparatus 1 during imaging is upright or vertical, and detects movement of the image pickup apparatus 1 (pan, tilt, etc.) based on the detected orientation.

A connection terminal 58 is provided to enable electrical communication with an external device that can be connected (attached) to the image pickup apparatus 1.

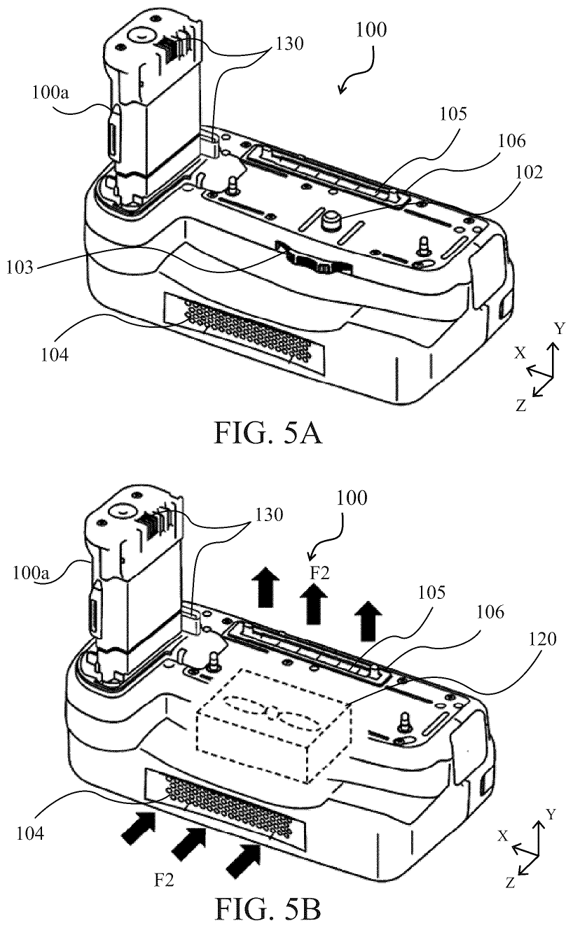

The cooling apparatus 100 is an example of an external device that can be connected to the image pickup apparatus 1, and is, for example, an accessory with an intake port and an exhaust port and a built-in fan, as illustrated in FIGS. 5A and 5B. The cooling apparatus 100 includes a power supply 101, a control unit 110, a fan 120, and a connection terminal 130. The control unit 110 controls the operation of the fan 120 while communicating with the image pickup apparatus 1 via the connection terminal 130.

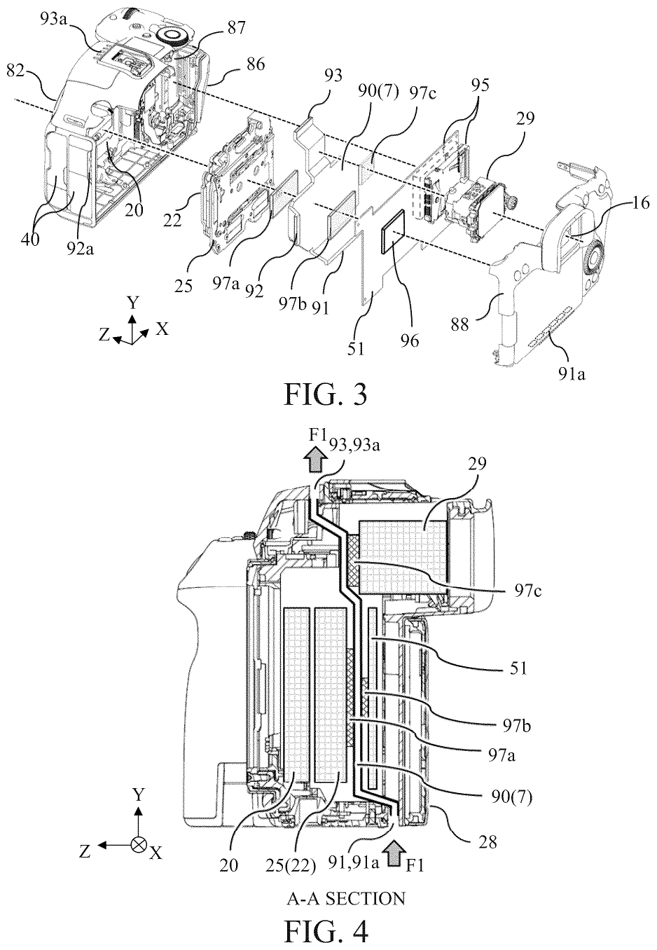

FIG. 3 illustrates an exploded view of the image pickup apparatus 1. FIG. 4 illustrates an A-A section passing through the optical axis of the imaging lens of the image pickup apparatus 1 illustrated in FIG. 1B. Arranged inside the housing including a front body 82 and a rear cover 88 are the shutter 20, an imaging unit 25 including the image sensor 22, a duct 90, a control board 51, and the EVF unit 29 in order from the object side. Also disposed inside the housing is a battery compartment 87 that houses a battery that constitutes the power supply unit 30. The control board 51 includes electrical components such as a processor element 96 (e.g., CPU, MPU, IC) that constitutes the camera control unit 50 and the image processing unit 24 illustrated in FIG. 2, and a card slot 95 into which the recording medium 85 is inserted.

Heat transfer members 97a, 97b, 97c, and 97d are made of materials with excellent thermal conductivity, such as thermal interface material (TIM). Details of the heat transfer members 97a to 97d will be described later.

As illustrated in FIG. 4, the duct 90 is a member that has an air flow path 7 formed therein. The duct 90 has an intake port 91 and an exhaust port (second exhaust port) 93 that open on the exterior surface of the image pickup apparatus 1, and has no opening inside the housing. In other words, the air flow path 7 is a flow path that does not communicate with the internal space of the image pickup apparatus 1. The air flow path 7 is a passage through which air flows as a fluid. Gases or liquids other than air may also be used as the fluid.

The bottom surface of the image pickup apparatus 1 has a flat shape, and the intake port 91 of the duct 90 may be widely formed. However, the variety of operation members, the terminal cover 40, the grip portion, etc. are provided on the exterior surface other than the bottom surface of the image pickup apparatus 1, it is difficult to form the exhaust port 93 that has a sectional area approximately the same as that of the intake port 91. Thus, the duct 90 in this embodiment has the intake port 91 facing the bottom surface of the image pickup apparatus 1, a first exhaust port 92 facing the left side surface of the image pickup apparatus 1 when viewed from the rear, and the second exhaust port 93 facing the top surface of the image pickup apparatus 1.

In this embodiment, the following inequality is satisfied:

$$0.9 \leq A 1 / A 2 \leq 1.1$$

where A1 is a sectional area of the intake port 91 of the duct 90, and A2 is the sum of the sectional areas of the first and second exhaust ports 92 and 93. In other words, the sectional area A1 of the intake port 91 and the sum A2 of the sectional areas of the first and second exhaust ports 92 and 93 are approximately equal.

In FIG. 3, a hole 92a is formed near the terminal cover 40 on the side of the image pickup apparatus 1. A plurality of holes 93a are also formed in the top of the image pickup apparatus 1. A plurality of holes 91a are also formed in the bottom surface of the rear cover 88. These holes 92a, 93a, and 91a are openings that penetrate through the exterior member of the image pickup apparatus 1 and are connected to the first exhaust port 92, second exhaust port 93, and intake port 91 of the duct 90, respectively, to prevent air leakage.

In this embodiment, a single exhaust port cannot secure a sectional area as large as the intake port 91. However, multiple exhaust ports, such as the first exhaust port 92 and the second exhaust port 93, are provided, and their total sectional area is equivalent to that of the intake port 91. This structure can improve the heat dissipation efficiency of the duct 90.

Next, the main heating elements in the image pickup apparatus 1 will be described. The imaging unit 25 according to this embodiment includes an image stabilizing mechanism for image stabilization. The image stabilizing mechanism includes a movable part including the image sensor 22 and a fixed part including an engagement part that is engaged with the front body 82. The movable part is pressed against the fixed part via a ball (not illustrated), allowing it to move in the X and Y directions orthogonal to the optical axis.

The image sensor 22 is a heating element (heat-generating element) that generates heat when capturing high-quality images or long-term imaging. The imaging unit 25 includes an A/D converter 23, which is a heating element that easily generates heat due to high-speed conversion of large analog signals to digital signals. Thus, in this embodiment, the imaging unit 25 including the image sensor 22 and A/D converter 23 is cooled.

The processor element 96 mounted on the control board 51 is a first heating element that generates heat by controlling the image pickup apparatus 1 and generating an image using a signal from the image sensor 22 (particularly by high-speed processing of huge amounts of image data obtained by imaging). For this reason, in this embodiment, the processor element 96 is cooled.

The EVF unit 29 housed inside the upper part of the image pickup apparatus 1 has a display element (referred to as the EVF display element hereinafter) that displays image data, etc., and the EVF display element is a third heating element. Thus, in this embodiment, the EVF unit 29 including the EVF display element is cooled.

The control board 51 also has the card slot 95 into which a recording medium 85 is inserted, and the recording medium 85 is a third heating element that generates heat in accordance with the amount of image data to be recorded. Heat from the recording medium 85 may be transferred to the control board 51 via the card slot 95. Thus, the card slot 95 including the recording medium 85 may be cooled, as will be explained in a fourth embodiment described later.

In the image pickup apparatus 1 according to this embodiment, in order to efficiently cool the imaging unit 25 and the control board 51 using the duct 90, the duct 90 is disposed between the imaging unit 25 and the control board 51 (i.e., between the image sensor 22 and the processor element 96). Also, in order to efficiently cool the EVF unit 29 using the duct 90, which EVF unit 29 is disposed above the imaging unit 25 and control board 51 inside the image pickup apparatus 1, the upper part of the duct 90 facing the second exhaust port 93 is disposed along the EVF unit 29. Thus, the duct 90 is disposed between the imaging unit 25 and the control board 51 and the EVF unit 29.

FIG. 4 illustrates the heat transfer members 97a, 97b, and 97c that transfer heat from the heating elements described above to the duct 90. The heat transfer members 97a, 97b, and 97c are disposed between the fixed part of the imaging unit 25 and the duct 90, between the control board 51 and the duct 90, and between the EVF unit 29 and the duct 90, respectively. They are in contact with and thermally connected to both each heating element and the duct 90. Based on manufacturing variations in each component, the heat transfer members 97a, 97b, and 97c may be elastically deformable and disposed in a compressed state so as not to separate from the components they contact. The heat transfer members 97a, 97b, and 97c may be made of not only the TIM described above, but also elastic metal bodies or graphite sheets, which may be curved and brought into contact with the respective components. In a case where the heating elements and the duct 90 can be mechanically fixed with screws or the like, a nonelastic heat transfer member such as a gap filler may also be used. This structure allows for efficient heat transfer from each heating element to the duct 90.

As heat from each heating element is transferred to the duct 90, which does not communicate with the internal space of the image pickup apparatus 1, the temperature of the air inside the duct 90 rises. As the air temperature rises, buoyancy generally occurs. Thus, as illustrated by arrow F1 in FIG. 4, external air flows into the duct 90 through the intake port 91, while heated air flows out through the first exhaust port 92 and second exhaust port 93 located above the intake port 91. This structure allows heat to be exhausted. In this way, the heating elements inside the image pickup apparatus 1 can be efficiently cooled naturally using the duct 90.

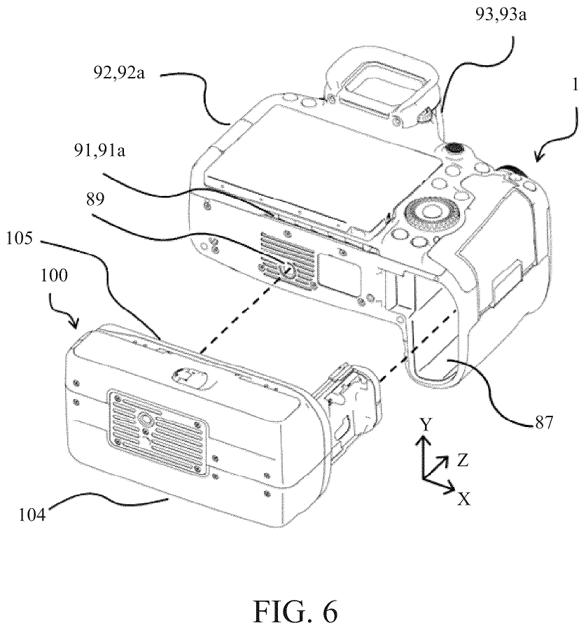

FIGS. 5A, 5B, and 6 illustrate the cooling apparatus 100 that is detachably attached to the image pickup apparatus 1. FIG. 5A illustrates the exterior of the cooling apparatus 100 viewed from the oblique front side, and FIG. 5B illustrates the cooling apparatus 100 illustrated in FIG. 5A and the fan 120 installed inside it. FIG. 6 illustrates the attachment of the cooling apparatus 100 to the image pickup apparatus 1.

As illustrated in FIG. 5A, a tripod screw 102 provided on the top surface of the cooling apparatus 100 can be engaged with a tripod screw fastening portion 89 provided on the bottom surface of the image pickup apparatus 1 illustrated in FIG. 6. The cooling apparatus 100 can be attached to the bottom of the image pickup apparatus 1 by turning the operation member 103 provided on the cooling apparatus 100. The cooling apparatus 100 can house a power supply 101 inside. The cooling apparatus 100 has a protrusion 100a that protrudes upward from the top surface, and connection terminals 130 are provided on the top and bottom of the protrusion 100a. The connection terminals 130 are provided on the top and bottom of the protrusion 100a. When the cooling apparatus 100 is attached to the image pickup apparatus 1, the protrusion 100a is inserted into the battery compartment 87 of the image pickup apparatus 1 and is connected to a communication terminal 58a of the image pickup apparatus 1 illustrated in FIG. 2, enabling communication between the cooling apparatus 100 and the image pickup apparatus 1.

As illustrated in FIG. 5B, the rotation of fan 120 provided inside the cooling apparatus 100 is controlled by the control unit 110 illustrated in FIG. 2. The fan 120 when rotating draws air in through the intake port 104 of the cooling apparatus 100, as indicated by arrow F2 in FIG. 5B, and causes air to flow out through exhaust port 105 of the cooling apparatus 100.

In a case where the cooling apparatus 100 is attached to the image pickup apparatus 1, the exhaust port 105 of the cooling apparatus 100 and the intake port 91 of the image pickup apparatus 1 are connected via a sealing member 106 provided around the exhaust port 105 of the cooling apparatus 100. As a result, air flowing out from the exhaust port 105 of the cooling apparatus 100 can flow from the intake port 91 of the image pickup apparatus 1 into the air flow path 7 in the duct 90 without leaking between the image pickup apparatus 1 and the cooling apparatus 100. This allows outside air to be forced into the duct 90 while air whose temperature has risen inside the duct 90 is forcibly exhausted, thereby forcibly cooling of the heating elements inside the image pickup apparatus 1 using air.

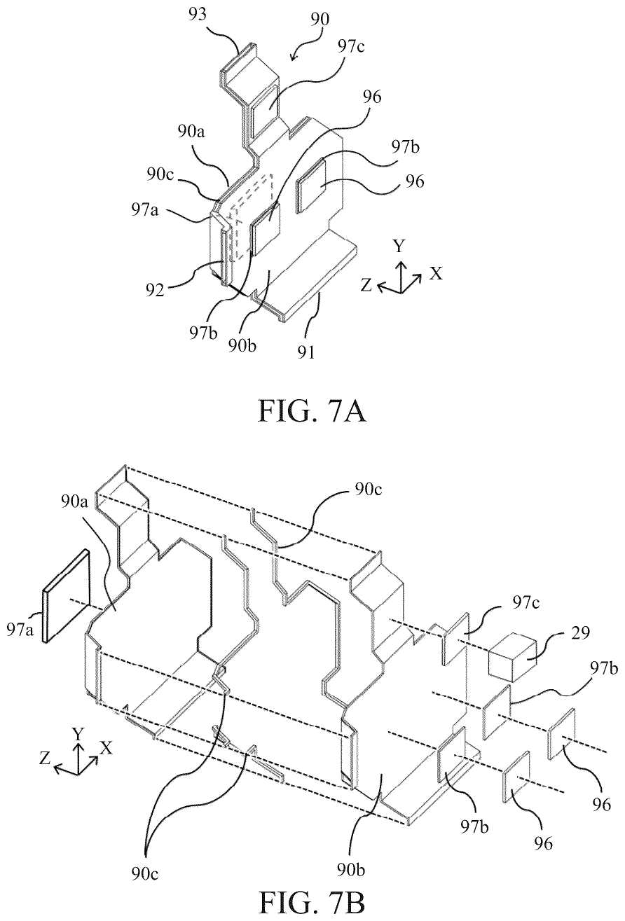

FIGS. 7A and 7B illustrate the structure of the duct 90. FIG. 7A is a rear perspective view of the duct 90 in an assembled state, and FIG. 7B is an exploded perspective view of the duct 90.

The duct 90 includes a first metal member 90a as the first duct member, a second metal member 90b as the second duct member, and a plurality of first thermal resistance members 90c. The first thermal resistance member 90c is disposed between the first metal member 90a on the front side and the second metal member 90b on the rear side. By closely fixing the first metal member 90a and the second metal member 90b to the first thermal resistance member 90c, the air flow path 7 is formed inside the duct 90 that does not communicate with the internal space of the image pickup apparatus 1.

The first metal member 90a and the second metal member 90b are made of a metal with high thermal conductivity. The first thermal resistance member 90c is a member that makes it difficult for heat to be transferred between the first metal member 90a and the second metal member 90b.

The first and second metal members 90a and 90b are made from the same or similar metallic materials with similar thermal properties and have a first thermal conductivity. The first thermal conductivity generally refers to a high thermal conductivity, and examples of such materials include copper, aluminum, aluminum alloys, and magnesium alloys. That the “first and second metal members have a first thermal conductivity” refers not only to cases where the first and second metal members have the same thermal conductivity, but also to cases where the first and second metal members have a slight (nonsignificant) difference in thermal conductivity within a range that can be considered identical. On the other hand, the first thermal resistance member 90c has a second thermal conductivity that is significantly lower than the first thermal conductivity, and may be made of aerogel, sealing material, elastomer, rubber, or the like.

The heat transfer member 97a contacts the lower outer surface of the first metal member 90a and the imaging unit 25. The heat transfer member 97b contacts the lower outer surface of the second metal member 90b and the processor element 96 mounted on the control board 51. In FIGS. 7A and 7B, two processor elements 96 are mounted on the control board 51, and two heat transfer members 97b contact the two processor elements 96 and the second metal member 90b. The heat transfer member 97c contacts the upper outer surface of the second metal member 90b and the EVF unit 29.

A cooling member other than the heat transfer member, such as thermal grease or a heat sink, may be disposed between each heat transfer member and the metal member and heating element which it contacts. In other words, the heat transfer member, metal member, and heating element may not be in direct contact with each other as long as they are thermally connected.

The heating elements to be preferentially radiated (cooled) in the image pickup apparatus 1 are the image sensor 22 and the processor elements 96. In a case where the duct 90, which is disposed between the imaging unit 25 and the control board 51, is formed as an integrated metal member or by fastening multiple metal members together with screws, heat from the image sensor 22 will be transferred to the processor element 96 mounted on the control board 51 via the imaging unit 25 and duct 90. Conversely, heat from the processor element 96 will be transferred to the image sensor 22 via the duct 90. As a result, heat from the higher temperature component of the image sensor 22 and the processor element 96 will be transferred to the lower temperature component, which may cause the lower temperature component to become hot (for example, exceeding the maximum permissible temperature).

Thus, in this embodiment, the duct 90 is disposed between the first metal member 90a serving as the first duct member on the image sensor 22 side and the second metal member 90b serving as the second duct member on the control board 51 side via the first thermal resistance member 90c. Due to the structure of the duct 90, heat is less likely to be transferred between the image sensor 22 and the processor element 96 through the duct 90, and the image sensor 22, processor element 96, and EVF display element can be efficiently cooled.

### Second Embodiment

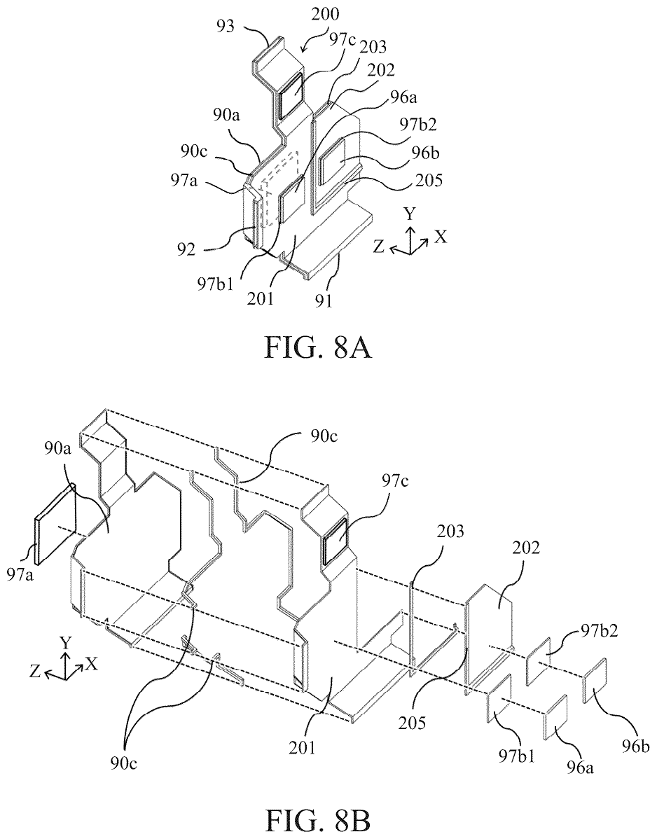

FIGS. 8A and 8B illustrate a duct 200 according to a second embodiment. FIG. 8A is a rear perspective view of the duct 200, and FIG. 8B is an exploded perspective view of the duct 200. In FIGS. 8A and 8B, components that are identical to those illustrated in the first embodiment (FIGS. 7A and 7B) are assigned the same reference numerals as in the first embodiment.

In the second embodiment, a processor element (first heating element) 96a and a processor element (second heating element) 96b, which have different temperatures during operations, are mounted on the same surface (XY plane) of the control board 51. The second metal member on the control board 51 side of the duct 200 is divided into a 2-1 metal member (first member) 201 to which heat from the processor element 96a is transferred via a heat transfer member 97b1, and a 2-2 metal member (second member) 202 to which heat from the processor element 96b is transferred via a heat transfer member 97b2. A second thermal resistance member 203 is disposed between the 2-1 metal member 201 and the 2-2 metal member 202. The second thermal resistance member 203 is made of the same material as that of the first thermal resistance member 90c and has the same second thermal conductivity as that of the first thermal resistance member 90c. However, the second thermal conductivity of the second thermal resistance member 203 and the second thermal conductivity of the first thermal resistance member 90c may not be the same, as long as they are lower than the first thermal conductivity.

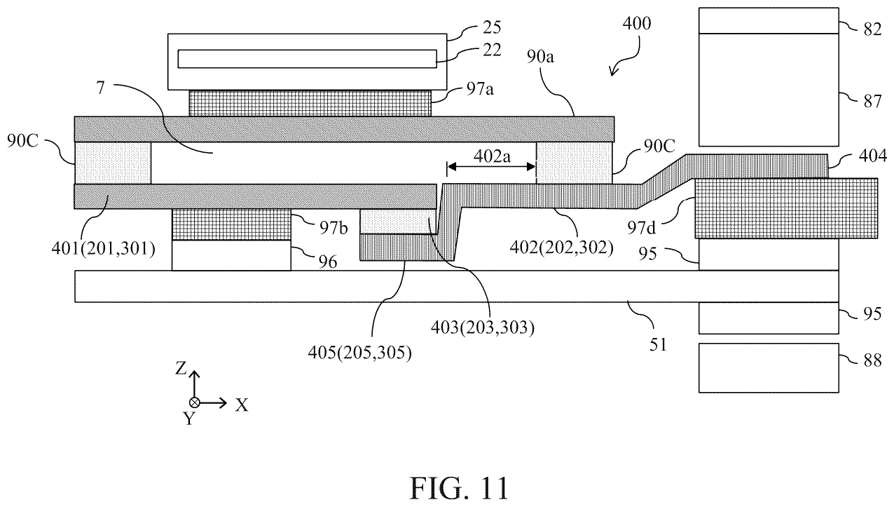

The 2-2 metal member 202 has a bent portion 205 for positioning the second thermal resistance member 203 between the 2-2 metal member 202 and the 2-1 metal member 201, and this will be discussed later in the fourth embodiment with reference to FIG. 11. The heat transfer member 97c that contacts the EVF unit 29 also contacts the 2-1 metal member 201.

Due to the structure of the duct 200, heat is less likely to be transferred between the processor elements 96a and 96b on the control board 51 via the duct 200.

Since the heat from the processor elements 96a and 96b is also transferred to other components mounted on the control board 51, the heat may be less likely to be transferred from the processor elements 96a and 96b to the other components using thermal lands or thermal vias in the wiring on the control board 51.

### Third Embodiment

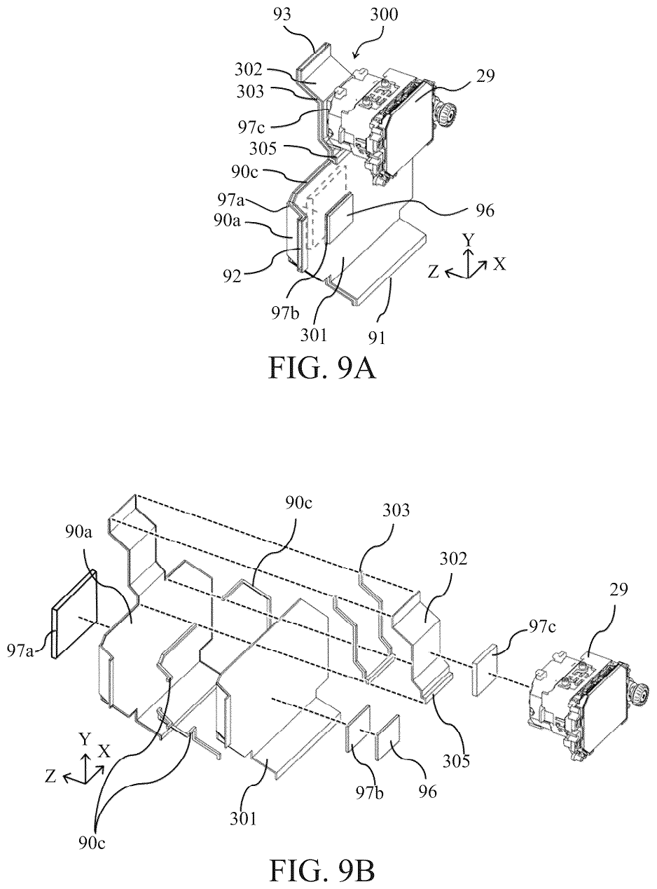

FIGS. 9A and 9B illustrate a duct 300 according to a third embodiment. FIG. 9A illustrates a rear perspective view of the duct 300, and FIG. 9B is an exploded perspective view of the duct 300. Those elements in FIGS. 9A and 9B, which are corresponding elements in in the first embodiment (FIGS. 7A and 7B), will be designated by the same reference numerals as in the first embodiment.

In the third embodiment, the second metal member on the control board 51 side and the EVF unit 29 side of the duct 300 is divided into a 2-1 metal member 301 to which heat from the processor element 96 is transferred via heat transfer member 97b, and a 2-2 metal member 302 to which heat from the EVF unit 29 is transferred via heat transfer member 97c. Furthermore, a second thermal resistance member 303 is disposed between the 2-1 metal member 301 and the 2-2 metal member 302. The 2-2 metal member 302 has a bent portion 305 for disposing the second thermal resistance member 303 between the 2-2 metal member 302 and the 2-1 metal member 301, and; this will be described in the fourth embodiment below with reference to FIG. 11.

Due to the structure of the duct 300, heat is less likely to be transferred between the processor element 96 on the control board 51 and the EVF unit 29 via the duct 300.

### Fourth Embodiment

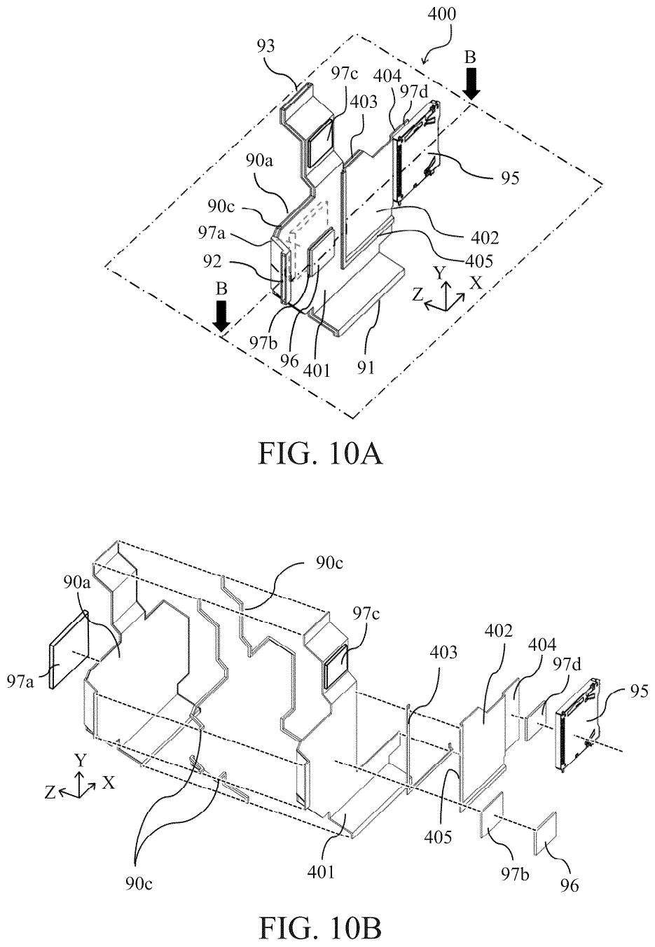

FIGS. 10A and 10B illustrate a duct 400 according to a fourth embodiment. FIG. 10A is a rear perspective view of the duct 400, and FIG. 10B is an exploded perspective view of the duct 400. Those elements in FIGS. 10A and 10B, which are corresponding elements in the first embodiment (FIGS. 7A and 7B), will be designated by the same reference numerals. FIG. 11 illustrates a cross section taken along a line B-B in FIG. 10A.

The duct 400 according to the fourth embodiment is used to cool the processor element 96 mounted on the front surface of the control board 51 and the card slot 95 mounted on the back surface of the control board 51 and into which the recording medium 85 is inserted.

In this embodiment, the second metal member of the duct 400 on the control board 51 side is divided into a 2-1 metal member 401 to which heat from the processor element 96 is transferred via a heat transfer member 97b, and a 2-2 metal member 402 to which heat from the card slot 95 is transferred. The 2-2 metal member 402 has an extension portion 404 that is not used to form an air flow path within the duct 400, and the extension portion 404 contacts a heat transfer member 97d that contacts the card slot 95. As a result, heat from the recording medium 85 is transferred to the 2-2 metal member 402 via the card slot 95 and the heat transfer member 97d.

A second thermal resistance member 403 is disposed between the 2-1 metal member 401 and the 2-2 metal member 402. The 2-2 metal member 402 has a bent portion 405 for positioning the second thermal resistance member 403 between the 2-2 metal member 402 and the 2-1 metal member 401.

Due to the structure of the duct 400, heat is less likely to be transferred between the processor element 96 on the control board 51 and the recording medium 85 via the duct 400.

The details of the bent portion 405 (bent portions 205 and 305 in FIGS. 8A, 8B, 9A, and 9B) will be described with reference to FIG. 11. The bent portion 205 illustrated in FIGS. 8A and 8B and the bent portion 405 illustrated in FIG. 10B extend in both the X and Y directions, while the bent portion 305 illustrated in FIGS. 9A and 9B extends only in the X direction, but they have the same basic shape.

Increasing the width of the air flow path 7 in the duct 400 in the Z direction increases an air amount flowing through it, and thereby the cooling effect can improve. However, increasing the width in the Z direction of the duct 400 increases the thickness in the Z direction of the image pickup apparatus 1. Thus, there are restrictions on the width in the Z direction of the duct 400.

If the bent portion 405 of the 2-2 metal member 402 is bent toward the inside of the air flow path 7, the sectional area of the air flow path 7 will be narrowed and the ventilation resistance of the air flow path 7 will increase. As a result, the air amount flowing through the air flow path 7 will decrease, and heat dissipation efficiency is reduced.

Accordingly, by bending the bent portion 405 toward the outside of the duct 400, on the opposite side of the air flow path 7, the second thermal resistance member 403 can be disposed between the 2-1 metal member 401 and the 2-2 metal member 402 without narrowing the sectional area of the air flow path 7 or increasing ventilation resistance. The bent portion may also be provided on the 2-1 metal member 401.

Without providing the bent portion 405, the second thermal resistance member 403 may be disposed between the 2-1 metal member 401 and the 2-2 metal member 402 by providing grooves into which the 2-1 metal member 401 and the 2-2 metal member 402 are engaged at both ends of the second thermal resistance member 403 in the X and Y directions.

Next, the reason why the extension portion 404 is not used to form the air flow path 7 will be explained. As illustrated in FIG. 3, the grip portion is provided on the right side of the image pickup apparatus 1 when viewed from the rear side. As illustrated in FIG. 11, the grip portion between the front body 82 and the rear cover 88 houses multiple components arranged in the Z direction, such as the battery compartment 87, part of the control board 51, and the card slot 95. Therefore, it is difficult to secure space within the grip portion to place a duct with an air flow path.

Hence, the extension portion 404 of the 2-2 metal member 402 that forms the duct 400, which is not used to form the air flow path 7 (does not contact the air flow path 7), is extended into the grip portion, and is thermally connected to the extension portion 404 and the card slot 95 via the heat transfer member 97d. The extension portion 404 may be in direct contact with the card slot 95.

Due to this structure, heat from the card slot 95 can be transferred via the extension portion 404 to an area 402a of the 2-2 metal member 402 that contacts the air flow path 7, without the need to place a duct with an air flow path in the grip portion. In other words, the card slot 95 can be cooled efficiently.

A third heating element other than the card slot 95, such as a component mounted on the control board 51 or the EVF unit 29, may also be thermally connected to the extension portion 404. The extension portion may also be provided on the 2-1 metal member, or on both the 2-1 and 2-2 metal members.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment according to the disclosure can provide an image pickup apparatus that can effectively cool each heating element.

This application claims the benefit of Japanese Patent Application No. 2024-215115, which was filed on Dec. 10, 2024, and which is hereby incorporated by reference herein in its entirety.

What is claimed is:

1. An image pickup apparatus comprising:
an image sensor;
a heating element different from the image sensor;
a duct disposed between the image sensor and the heating element, and forming a flow path for fluid inside the duct;
wherein the duct includes:
a first duct member thermally connected to the image sensor and having a first thermal conductivity,
a second duct member thermally connected to the heating element and having the first thermal conductivity, and
a first thermal resistance member disposed between the first duct member and the second duct member and having a second thermal conductivity lower than the first thermal conductivity.

2. The image pickup apparatus according to claim 1, wherein each of the first duct member and the second duct member is made of metal.

3. The image pickup apparatus according to claim 1, the heating element includes a first heating element and a second heating element, and
wherein the second duct member includes:
a first member thermally connected to the first heating element,
a second member thermally connected to the second heating element, and
a second thermal resistance member disposed between the first member and the second member and having the second thermal conductivity.

4. The image pickup apparatus according to claim 3, wherein one of the first member and the second member has a bent portion bent toward outside of the duct, and
wherein the second thermal resistance member is disposed between the bent portion and another of the first member and the second member.

5. The image pickup apparatus according to claim 3, wherein the first heating element and the second heating element are processor elements configured to control the image pickup apparatus or generate an image using a signal from the image sensor.

6. The image pickup apparatus according to claim 3, wherein the first heating element is a processor element configured to control the image pickup apparatus or generates an image using a signal from the image sensor, and
wherein the second heating element is a display element configured to display the image.

7. The image pickup apparatus according to claim 1, wherein the duct has:
an intake port connected to an opening provided on a bottom surface of the image pickup apparatus, and
a first exhaust port connected to a first opening provided in a side surface of the image pickup apparatus, and
a second exhaust port connected to a second opening provided in a top surface of the image pickup apparatus.

8. The image pickup apparatus according to claim 7, wherein the following inequality is satisfied:
0.9≤A1/A2≤1.1
where A1 is a sectional area of the intake port, and A2 is a sum of a sectional area of the first exhaust port and a sectional area of the second exhaust port.

9. The image pickup apparatus according to claim 1, wherein at least one of the first duct member and the second duct member has an extension portion that is not used to form the flow path and is thermally connected to a third heating element serving as the heating element.

10. The image pickup apparatus according to claim 9, wherein the extension portion and the third heating element are disposed inside a grip portion of the image pickup apparatus.

11. The image pickup apparatus according to claim 9, wherein the third heating element includes a recording medium.

12. The image pickup apparatus according to claim 1, wherein the image pickup apparatus is attachable to and detachable from a cooling apparatus configured to send the fluid into an intake port in the duct.
